(19) United States
(12) Patent Application Publication
(10) Pub. No.: US 2026/0222896 A1
(43) Pub. Date: Jul. 30, 2026

(54) METHOD AND APPARATUS FOR QOS PROFILE DISCOVERY

(71) Applicants: Fengpei ZHANG, Guangzhou, Guangdong (CN); TELEFONAKTIEBOLAGET LM ERICSSON (PUBL), Stockholm (SE)

(72) Inventors: Fengpei Zhang, GUANGZHOU (CN); Miguel Angel Garcia Martin, MADRID (ES); Thorsten Lohmar, AACHEN (DE)

(73) Assignee: TELEFONAKTIEBOLAGET LM ERICSSON (PUBL), Stockholm (SE)

(21) Appl. No.: 19/140,952

(22) PCT Filed: Dec. 18, 2023
(86) PCT No.: PCT/CN2023/139400

§ 371 Date: Jun. 18, 2025

(30) Foreign Application Priority Data
Dec. 19, 2022 (WO) PCT/CN2022/140001

(51) Int. Cl. H04W 28/02

(52) U.S. Cl. CPC H04W 28/0268

(57) ABSTRACT

Embodiments of the present disclosure provide methods, apparatus, and computer program products for QoS profile discovery. A method implemented at a network node comprises: receiving from an application function node, a first request for a profile of quality of service, QoS, for one or more user equipments, UEs; creating a second request for the profile of QoS according to the first request; transmitting the second request to a network policy related function node or a support system associated with the one or more UEs; receiving from the network policy related function node or the support system, one or more profiles of QoS applicable to the one or more UEs; and transmitting the one or more profiles of QoS to the application function node.

### TECHNICAL FIELD

The non-limiting and exemplary embodiments of the present disclosure generally relate to the technical field of quality of service (QoS) for communications, and specifically to methods, apparatuses and computer programs for QoS profile discovery.

### BACKGROUND

This section introduces aspects that may facilitate a better understanding of the disclosure. Accordingly, the statements of this section are to be read in this light and are not to be understood as admissions about what is in the prior art or what is not in the prior art.

Mobile networks provide a “Quality of Service (QoS)” mechanism to control traffic to satisfy the implied or stated needs of critical application communication under limited network capacity.

In a 5^{th} generation (5G) system, QoS is always applied to one or more QoS flows within a packet data unit (PDU) session. A QoS flow is defined as the smallest granularity for differentiating traffic in terms of QoS, scheduling, queue management, rate shaping, etc.

Each QoS flow is characterized by a set of QoS attributes that are in turn divided into QoS characteristics and QoS parameters. An application, for example, an application running in an application server, to which a client application in the UE has established one or more application flows, can select values for QoS attributes as required for each flow. Once a PDU session has been successfully established, the 5G system is responsible for providing the required QoS for each QoS flow.

It would be desired to provide mechanisms for setting up suitable QoS for one or more QoS flows within a PDU session flexibly and effectively.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Various embodiments of the present disclosure mainly aim at providing approaches for QoS profile discovery, so as to flexibly and effectively facilitate setting up and/or modifying suitable QoS for one or more QoS flows within a PDU session. To support the QoS profile discovery, a specific application programing interface (API), referred to as QoS Profile Discovery API in this disclosure, can be defined and hosted in a network node, such as network exposure function (NEF) or service control exposure server (SCEF).

The approaches are particularly advantageously implemented in a 5G telecommunication network or 5G core network, in particular according to 3GPP (3^{rd} Generation Partnership Project, a standardization organization). The approaches are also particularly advantageously implemented in CAMARA (a standardization organization), which is a telco global API alliance to address challenges in porting and reproducing API services across heterogenous operator and cloud architectures.

Other features and advantages of embodiments of the present disclosure will also be understood from the following description of specific embodiments when read in conjunction with the accompanying drawings, which illustrate, by way of example, the principles of embodiments of the present disclosure.

In a first aspect of the present disclosure, there is provided a method implemented at a network node. The method comprises receiving from an application function node, a first request for a profile of quality of service, QoS, for one or more user equipments, UEs; creating a second request for the profile of QoS according to the first request; transmitting the second request to a network policy related function node or a support system associated with the one or more UEs; receiving from the network policy related function node or the support system, one or more profiles of QoS applicable to the one or more UEs; and transmitting the one or more profiles of QoS to the application function node. The network node may comprise a network exposure server, NEF, or a service capability exposure server, SCEF.

In some embodiments, the method may further comprise: determining, according to the first request, the network policy control function node or the support system to which the second request is to be transmitted.

In some embodiments, determining the network policy control function node or the support system may comprise: determining if there is a network policy related function node being serving the one or more UEs; and if there is a particular network policy related function node being serving the one or more UEs, selecting the particular network policy related function node to transmit the second request to it.

In some embodiments, determining the network policy control function node or the support system may comprise: determining if there is a network policy related function node being serving the one or more UEs; and if there is no network policy related function node being serving the one or more UEs, selecting a network policy related function node or a support system for the one or more UEs to transmit the second request to it.

In some embodiments, the first request may comprise the following parameters: an identity of the application node; one or more identifiers of the one or more UEs; and one or more parameters related to a requested profile of QoS.

In some embodiments, the second request may comprise the following parameters: an identity of the application node; single network slice selection assistance information related to the application function node; a data network name related to the application function node; one or more identifiers of the one or more UEs; and one or more parameters related to a requested profile of QoS.

In some embodiments, the one or more identifiers of the one or more UEs may comprise at least one of the following: respective identities of the one or more UEs; an identity of a group which the one or more UEs belong to; and an identifier of a category which the one or more UEs belong to.

In some embodiments, the one or more parameters related to the requested profile of QoS may comprise one or more QoS attributions requested for the one or more UEs.

In some embodiments, the one or more profiles of QoS applicable to the one or more UEs may comprise at least one of the following items: respective QoS references of the one or more profiles; one or more QoS characteristics related to the one or more parameters in the first request; and one or more QoS parameters related to the one or more parameters in the first request.

In a second aspect of the present disclosure, there is provided a method implemented at a network policy related function node or a support system. The method comprises receiving from a network exposure server, NEF, or a service capability exposure server, SCEF, a second request for a profile of quality of service, QoS, for one or more UEs served by an application function node; determining one or more profiles of QoS applicable to the one or more UEs according to the second request; and transmitting the one or more profiles of QoS to the NEF or the SCEF.

In some embodiments, the network policy related function node may comprise a policy control function, PCF, node or a policy charging rules function, PCRF, node.

In a third aspect of the present disclosure, there is provided a method implemented at an application function node. The method comprises: creating a first request for a profile of quality of service, QoS, for one or more user equipments, UEs; transmitting the first request to a network exposure server, NEF, or a service capability exposure server, SCEF; and receiving from the NEF or SCEF, one or more profiles of QoS applicable to the one or more UEs.

In a fourth aspect of the present disclosure, there is provided an apparatus at a network node. The apparatus may comprise a processor and a memory coupled to the processor. The memory may contain instructions executable by the processor, whereby the apparatus is operative to perform any step of the method according to the first aspect of the disclosure.

In a fifth aspect of the present disclosure, there is provided an apparatus at a network policy related function node or a support system. The apparatus may comprise a processor and a memory coupled to the processor. The memory may contain instructions executable by the processor, whereby the apparatus is operative to perform any step of the method according to the second aspect of the disclosure.

In a sixth aspect of the present disclosure, there is provided an apparatus at an application function node. The apparatus may comprise a processor and a memory coupled to the processor. The memory may contain instructions executable by the processor, whereby the apparatus is operative to perform any step of the method according to the third aspect of the disclosure.

In a seventh aspect of the present disclosure, there is provided a computer-readable medium having computer program codes embodied thereon which, when executed on a computer, cause the computer to perform any step of the method according to the first aspect of the present disclosure.

In an eighth aspect of the present disclosure, there is provided a computer-readable medium having computer program codes embodied thereon which, when executed on a computer, cause the computer to perform any step of the method according to the second aspect of the present disclosure.

In a ninth aspect of the present disclosure, there is provided a computer-readable medium having computer program codes embodied thereon which, when executed on a computer, cause the computer to perform any step of the method according to the third aspect of the present disclosure.

According to the various aspects and embodiments as mentioned above, an AF developer can discover suitable QoS profiles to fulfil service needs flexibly and effectively.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates a schematic diagram of 5G QoS model;

FIG. 2 illustrates a schematic diagram of an exemplary architecture according to some embodiments of the present disclosure;

FIG. 3 is a signaling diagram illustrating an exemplary procedure according to some embodiments of the present disclosure;

FIG. 4 illustrates a flowchart of a method according to some embodiments of the present disclosure;

FIG. 5 illustrates a flowchart of a method according to some embodiments of the present disclosure;

FIG. 6 illustrates a flowchart of a method according to some embodiments of the present disclosure;

FIG. 7 illustrates a simplified block diagram of an apparatus 700 that may be embodied in/as a network node (such as a NEF, SCEF), a network policy related function node (such as PCF, PCRF), an support system (such as OSS, BSS), or an application function node (such as an AF), and some of its components configured according to an embodiment of the present disclosure;

FIG. 8 is a functional block diagram of processing circuitry in a network node, such as an NEF, operating according to an embodiment of the present disclosure;

FIG. 9 is a functional block diagram of processing circuitry in a network policy related function node (such as PCF, PCRF) or an support system (such as OSS, BSS), operating according to an embodiment of the present disclosure; and

FIG. 10 is a functional block diagram of processing circuitry in an application function node, such as an AF, operating according to an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure.

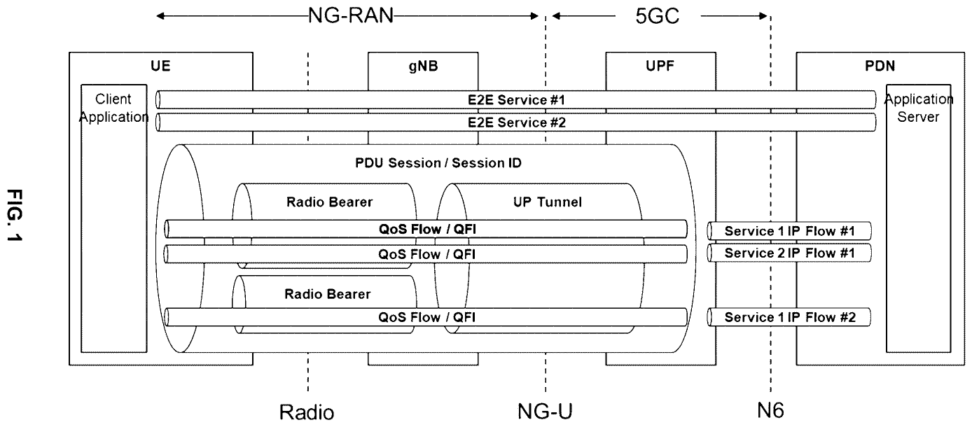

This disclosure focuses on schemes for QoS profile delivery, so as to allow for setting up suitable QoS for one or more QoS flows within a PDU session flexibly and effectively. As mentioned above, a QoS flow is defined as the smallest granularity for differentiating traffic in terms of QoS. In the following, concepts and approaches are described in the context of 5G core (5GC) network technology by way of example. FIG. 1 illustrates a schematic diagram of 5G QoS model.

For each UE, 5GC can establish one or more PDU sessions. In normal mobile broadband (MBB) cases, a MBB related PDU Session is configured with a single QoS flow, which is used to carry all different application flows. A default QoS policy is applied to this default QoS flow. Additional QoS flows can be activated with more specific QoS. Multiple application flows can be carried as one QoS Flow.

All packets (PDUs) belonging to a same QoS flow are marked with the same QoS Flow Identifier (QFI) value. The QFI is carried within the service data adaptation protocol (SDAP) headers over the radio bearers and within general packet radio services (GPRS) tunneling protocol user plane (GTP-U) extension headers through the 5G core network.

Several mechanisms are available for setting up required QoS for one or more QoS flows within a PDU session:
Subscription-based QoS: Every subscription is provisioned with a default QoS, defining the QoS for a default QoS flow. Whenever a UE establishes a new PDU session, a default QoS is allocated to every application flow of such PDU session. Once the PDU session is established with a default QoS, the UE, the network, or an application server may modify the QoS of one or more QoS flows of the PDU session (using one of the subsequent mechanisms).
UE-controlled QoS (UE triggered PDU session modification on non-access stratum (NAS)): When a connection to a UE is established by an application hosted in the UE, APIs in its modem (e.g. by AT commands, as defined in 3GPP TS 27.007) specify a QoS level. The application hosted in the UE therefore has complete flexibility for defining a QoS profile and modifying QoS profiles of previously established connections. For example, the UE may use a “UE requested PDU Session Modification” Procedure, e.g., as defined in Clause 4.3.3.2 in 3GPP TS 23.502, V17.6.0, for requesting a new QoS flow or a modified QoS flow. Note, that many (or even all) public networks reject any QoS request by a UE requested PDU session modification.
Network-exposure-controlled QoS: An application function (AF) can dynamically choose QoS parameters for a specific UE and for certain QoS flow, and request this QoS to the network, via an API exposed by a network exposure function (NEF) or a service capability exposure function (SCEF). For example, the AF may trigger a “Network requested PDU Session Modification Procedure to activate a new QoS Flow or a modified QoS flow. For example, as defined in Clause 4.3.3.2 in 3GPP TS 23.502, V17.6.0, a PCF initiated SM Policy Association Modification may be triggered upon AF requests, e.g. Application Function influence on traffic routing or AF to provide Port management information Container.

In terms of network-exposure-controlled QoS, an NEF or SCEF may provide an AfSessionWithQoS API (which is very similar to the SCEF AsSessionwithQoS API, as defined in 3GPP TS 29.122, V17.6.0) for setting up an AS session with required QoS.

The current 3GPP AfSessionwithQoS API provides the “qosReference” and (optionally) “altQoSReferences” parameters to specify the QoS information requested by an AF. An exemplary data structure used by the current AfSessionwithQoS API is shown in Table 1, similarly as that of AsSessionwithQoS API specified in chapter 5.14.2 of 3GPP TS 29.122, V17.6.0.

TABLE 1
Definition of type AfSessionwithQosSubscription

| | | | | Applicability |
|---|---|---|---|---|
| Attribute name | Data type | Cardinality | Description | (NOTE 1) |
| self | Link | 0 . . . 1 | Link to the resource “Individual AS Session with | |
| | | | Required QoS Subscription”. | |
| | | | This parameter shall be supplied by the SCEF in | |
| | | | HTTP responses. | |
| dnn | Dnn | 0 . . . 1 | Identifies a DNN, a full DNN with both the | |
| | | | Network Identifier and Operator Identifier, or a | |
| | | | DNN with the Network Identifier only. | |
| | | | (NOTE 3) | |
| snssai | Snssai | 0 . . . 1 | Identifies an S-NSSAI. (NOTE 3) | |
| supportedFeatures | SupportedFeatures | 0 . . . 1 | Used to negotiate the supported optional features | |
| | | | of the API as described in subclause 5.2.7. | |
| | | | This attribute shall be provided in the POST | |
| | | | request and in the response of successful | |
| | | | resource creation. | |
| notificationDestination | Link | 1 | Contains the URL to receive the notification | |
| | | | bearer level event(s) from the SCEF. | |
| exterAppId | string | 0 . . . 1 | Identifies the external Application Identifier. | AppId |
| | | | (NOTE 2) | |
| flowInfo | array(FlowInfo) | 0 . . . N | Describe the IP data flow which requires QoS. | |
| | | | (NOTE 2) | |
| ethFlowInfo | array(EthFlowDescription) | 0 . . . N | Identifies Ethernet packet flows. | EthAsSessionQoS_5G |
| | | | (NOTE 2) | |
| qosReference | string | 0 . . . 1 | Identifies a pre-defined QoS information | |
| altQoSReferences | array(string) | 0 . . . N | Identifies an ordered list of pre-defined QoS | AlternativeQoS_5G |
| | | | information. The lower the index of the array | |
| | | | for a given entry, the higher the priority. | |
| | | | (NOTE 4) | |
| altQosReqs | array(AlternativeSer- | 0 . . . N | Identifies an ordered list of alternative service | AltQosWithIndParams_5G |
| | viceRequirementsData) | | requirements that include individual QoS | |
| | | | parameter sets. The lower the index of the array | |
| | | | for a given entry, the higher the priority. | |
| | | | (NOTE 4) | |
| disUeNotif | boolean | 0 . . . 1 | Indicates to disable QoS flow parameters | DisableUENotifica- |
| | | | signalling to the UE when the SMF is notified by | tion_5G |
| | | | the NG-RAN of changes in the fulfilled QoS | |
| | | | situation when it is included and set to “true”. | |
| | | | The fulfilled situation is either the QoS profile or | |
| | | | an Alternative QoS Profile. The default value | |
| | | | “false” shall apply, if the attribute is not present | |
| | | | and has not been supplied previously. | |
| ueIpv4Addr | Ipv4Addr | 0 . . . 1 | The Ipv4 address of the UE. | |
| | | | (NOTE 2) | |
| ipDomain | string | 0 . . . 1 | The IPV4 address domain identifier. | |
| | | | The attribute may only be provided if the | |
| | | | ueIpv4Addr attribute is present. | |
| ueIpv6Addr | Ipv6Addr | 0 . . . 1 | The Ipv6 address of the UE. | |
| | | | (NOTE 2) | |
| macAddr | MacAddr48 | 0 . . . 1 | Identifies the MAC address. | EthAsSessionQoS_5G |
| | | | (NOTE 2) | |
| usageThreshold | UsageThreshold | 0 . . . 1 | Time period and/or traffic volume in which the | |
| | | | QoS is to be applied. | |
| sponsorInfo | SponsorInformation | 0 . . . 1 | Indicates a sponsor information | |
| qosMonInfo | QosMonitoringInformation | 0 . . . 1 | Qos Monitoring information. It can be present | QoSMonitoring_5G |
| | | | when the event “QOS_MONITORING” is | |
| | | | subscribed. | |
| directNotifInd | boolean | 0 . . . 1 | Indicates that the direct event notification is | ExposureToEAS |
| | | | requested if it is included and set to true | |
| tscQosReq | TscQosRequirement | 0 . . . 1 | Contains the QoS requirements for time sensitive | TSC_5G |
| | | | communication. | |
| requestTestNotification | boolean | 0 . . . 1 | Set to true by the SCS/AS to request the SCEF to | Notification_test_event |
| | | | send a test notification as defined in | |
| | | | subclause 5.2.5.3. Set to false or omitted | |
| | | | otherwise. | |
| websockNotifConfig | WebsockNotifConfig | 0 . . . 1 | Configuration parameters to set up notification | Notification_websocket |
| | | | delivery over Websocket protocol as defined in | |
| | | | subclause 5.2.5.4. | |
| events | array(UserPlaneEvent) | 0 . . . N | Corresponds to the list of user plane event(s) to | enNB |
| | | | which the SCS/AS requests to subscribe to. | |

(NOTE 1):
Properties marked with a feature as defined in subclause 5.14.4 are applicable as described in subclause 5.2.7. If no features are indicated, the related property applies for all the features.
(NOTE 2):
One of “ueIpv4Addr”, “ueIpv6Addr” or “macAddr” shall be included. If ipv4 or ipv6 address is provided, IP flow information shall be provided. If MAC address is provided and the AppId feature is not supported, Ethernet flow information shall be provided. If the AppId feature is supported, one of IP flow information, Ethernet flow information (if EthChgParty_5G is supported) or External Application Identifier shall be provided.
(NOTE 3):
The property is only applicable for the NEF.
(NOTE 4):
The attributes “altQoSReferences” and “altQosReqs” are mutually exclusive. Of the two, only the attribute “altQoSReferences” may be provided if the attribute “qosReference” is provided, while only the attribute “altQosReqs” may be provided if the attribute “qosReference” is not provided.

As defined in Table 1, in current AfSessionWithQos API, QoS reference (such as the attribute “qosReference” and “altQoSReferences”) is used to specify required QoS for setting up or modifying an AF session. It should be noted that the QoS reference is not QoS attribute itself, but a string or identifier referring to predefined QoS information of related QoS attributes in the NEF or SCEF. The current 3GPP AfSessionWithQos API assumes that an AF operator has previously agreed with a mobile network operator which is the QoS information associated with respective QoS references through an out-of-band manner. For example, QoS information associated with respective QoS references can be offered to an AF operator in the service level agreement (SLA) documentation of the connectivity service. A QoS reference can be mapped to a set of particular QoS attributes such as media component descriptions (e.g., bandwidth, media type), according to the SLA. In other words, each QoS reference points to a set of QoS attributes that are at the AF disposal for requesting a certain QoS for one or more QoS flows of a UE.

The fact that the QoS attributes to which a QoS reference refers to is part of an SLA and is typically delivered as part of a document, brings difficulty or even mistakes to AF development. In this regard, copying from SLA documentation to APIs (such as AfSessionWithQos API) of AF, respective QoS references mapped to different set of QoS attributes for different QoS flow of various applications for a mass of UEs, is a tedious and error-prone operation.

Further, the out-of-band QoS information (e.g., pre-defined and recited in an SLA documentation) is not machine readable. It is hard to make the network-exposure-controlled QoS procedure fully automate (so called “zero-touch”) and adaptive. It becomes practically impossible to change QoS references, once the QoS references are handed out to an AF operator with SLA documentation. For example, the SLA documentation handed out to the AF operator may define a particular QoS reference mapping to a first set of QoS attributes. After a while, the mobile network operator may change some QoS attributes in the first set, for example due to changes in network configurations. Accordingly, the QoS reference mapping to the first set is changed. Since it is hard to adjust the SLA documentation through an out-of-band manner in real time, the AF operator cannot change the QoS reference in time.

The present disclosure provides approaches for an AF to discover eligible QoS references that represent QoS profiles for a given UE or a given category of UEs. The AF sends to a network node, a discovery query with query parameters. In some embodiments, a new QoS profile discovery service is defined within NEF or SCEF. This service exposes an API that allows AFs to invoke to discover eligible QoS profiles for a given UE or a given category of UEs. The AF uses the QoS profile discovery API to discover eligible QoS references identifying QoS profiles that are eligible to the given UE or the given UE category. Then, the AF may, at a later time, use the discovered QoS references (that point to the discovered QoS profiles) in any other NEF API, such as the AfSessionWithQos API.

In an embodiment, the discovery query takes as input an identifier of the UE (e.g., unique subscription permanent identifier (SUPI), global public subscription identifier (GPSI)). In the network node, the discovery query may be filtered based on the query parameters. The network node may provide a response with the applicable QoS references and QoS attributes that apply to every category the UE belongs to. In another embodiment, the discovery query takes as input a UE category rather than the identifier of the target UE. The network provides a response with the applicable QoS references and QoS attributes that apply to the specified UE category. In another embodiment, the discovery query takes individual QoS attributes as input parameter, and the response provides the QoS references and the associated QoS attributes for the QoS references in the response. This allows the AF to query e.g., all QoS references for a certain QoS attribute, such as “Packet Delay Budget equals 300 ms” or “Packet Delay Budget smaller than 100 ms”. Once the AF has discovered the eligible QoS references for a given UE or a given UE category, the AF can use the discovered QoS references, e.g., when invoking an AfSessionwithQoS API.

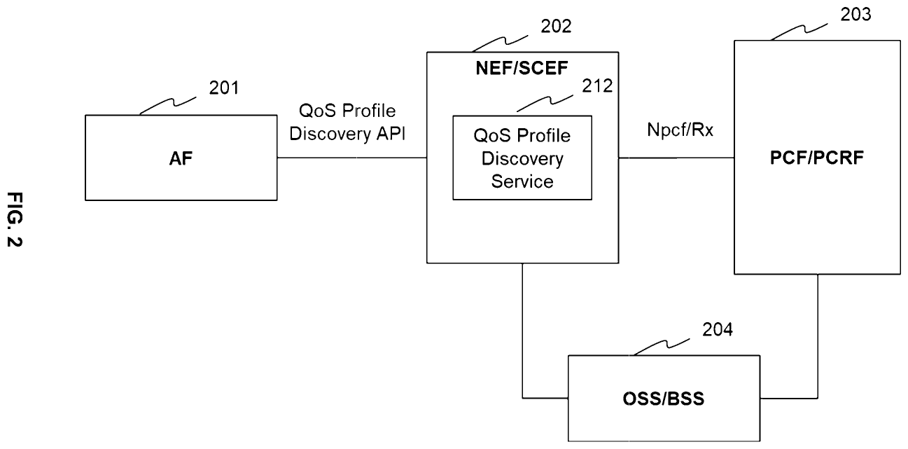

FIG. 2 illustrates a schematic diagram of an exemplary architecture according to an embodiment of the present disclosure. As shown in FIG. 2, a QoS profile discovery service 212 is introduced and implemented within in NEF/SCEF 202, in a way similar to other services provided by the NEF and/or SCEF. This QoS profile discovery service 212 provides a QoS profile discovery API for one or more application function nodes (such as AF 201) to consume. AF 201 may be various services of an application layer. It may be a normal AF in 5G network architecture. It could be either untrusted (outside communication service provider (CSP) domain) or trusted (inside CSP domain). For example, AF 201 may be hosted in an application server outside the 5GC.

SCEF is a functional element in the 4th generation (4G) core network, which provides means to securely expose the services and capabilities provided by 3GPP network interfaces. SCEF provides access to network capabilities through homogenous application programming interfaces. Individual instances of SCEF may vary depending on what service capabilities are exposed and what API features are supported.

NEF is a function element in 5G core network equivalent to the 4G SCEF. It is responsible for managing the exposure of network data. All external applications that want to access the internal data of 5G core network must pass NEF.

PCF/PCRF 203 is a network policy related function node, which can provide NEF/SCEF 202 with QoS policies related to a given UE or a given UE category. PCF is a network policy control function in 5G core network, and is equivalent to 4G PCRF. SCEF can act as an AF to interact with the PCRF via the Rx interface. NEF can interact with the PCF via the Npcf interface.

In other embodiments, NEF/SCEF 202 can retrieve QoS information related to a given UE or a given UE category from a support system, such as BSS (business support systems)/OSS (operation support systems) 204, for the given UEs.

The following concepts are used in different embodiments of this disclosure. A QoS flow is the smallest level granularity within a 5G system and is where policy and charging are enforced. A QoS profile consists of a set of attributes, used as a monolithic group of QoS attributes, such as 5QI, flow bit rates, maximum packet loss rate, etc. A QoS flow can be parametrized by a QoS profile. Multiple application flows can be carried by a single QoS flow. Service data flow filters are used to identify, which application flow packets should be carried by what QoS flow. Each QoS flow is identified with a QoS flow identifier (QFI) that determines the QoS attributes that apply to the QoS flow. The QFI can be dynamically assigned by the network (in which case, it requires the signaling of 5G QoS characteristics) or may be equal to the 5G QoS identifier (5QI). The 5QI identifies a set of standardized and tabulated values for the QoS characteristics as part of QoS profile. The QoS characteristics include resource type, priority level, packet delay budget and etc. The QoS reference is used as a pointer to the QoS profile.

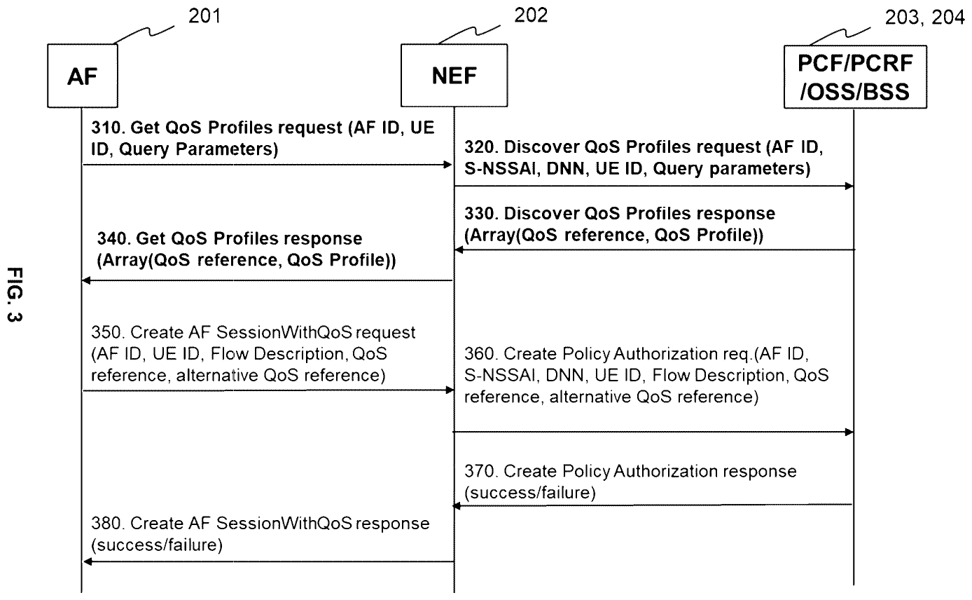

FIG. 3 is a signaling diagram illustrating an exemplary procedure according to an embodiment of the present disclosure. In FIG. 3, AF 201, NEF 202 and PCF 203 may be arranged to connect and communicate with each other as described in conjunction with FIG. 2.

As shown at step 310, the AF 201 sends a “Get QoS Profiles” request to the NEF 202, to discovery eligible QoS references or QoS profiles for a target UE. The AF 201 may include its own AF identifier and an identifier of the target UE in the request. The AF 201 may further include QoS query parameters in the request to filter related results. The QoS query parameters may indicate certain QoS requirements for the given UE. For example, the QoS query parameters may comprise one or more or all of the information elements as shown in Table 2. It should be appreciated that the QoS query parameters are not limited to the information elements in Table 2, but may comprise any other information elements for filtering QoS references or QoS profiles for the target UE.

TABLE 2
URI Query Parameters (Filters)

| Information Element | Description |
|---|---|
| 5QI | The 5QI value. |
| Resource Type | The QoS resource type indicating |
| | a QoS Flow is non-GBR, non-delay |
| | critical GBR or delay critical |
| | GBR. |
| Allocation and Retention | The 5QI priority level (see clauses |
| Priority | 5.7.3.3 and 5.7.4 of 3GPP TS |
| | 23.501). |
| Packet Delay Budget | The packet delay budget (see |
| | clauses 5.7.3.4 and 5.7.4 of 3GPP |
| | TS 23.501). |
| Packet Error Rate | The packet error rate. |
| Averaging Window | The averaging window (see clause |
| | 5.7.3.6 and 5.7.4 of 3GPP TS 23.501). |
| Maximum Data Burst | The maximum data burst volume (see |
| Volume | clauses 5.7.3.7 and 5.7.4 of 3GPP TS |
| | 23.501). |
| Guaranteed Flow Bit Rate | The guaranteed flow bit rate in uplink. |
| Uplink | |
| Guaranteed Flow Bit Rate | The guaranteed flow bit rate in |
| Downlink | downlink. |
| Maximum Flow Bit Rate Uplink | The maximum flow bit rate in uplink. |
| Maximum Flow Bit Rate | The maximum flow bit rate in |
| Downlink | downlink. |
| Maximum Packet Loss Rate | The maximum packet loss rate in |
| Uplink | uplink. |
| Maximum Packet Loss Rate | The maximum packet loss rate in |
| Downlink | downlink. |

In response to a reception of the “Get QoS Profiles” request from the AF 201, the NEF 202 may call a QoS profile discovery service 212 (or other functional module hosted in the NEF). The QoS profile discovery service (or other functional module) may determine single-network slice selection assistance information (S-NSSAI) and data network name (DNN) associated with the AF 201, according to the AF identifier received in the “Get QoS Profiles” request.

Then, according to the received query parameters, the NEF 202 (or the QoS profile discovery service 212) would try to retrieve QoS profiles for the target UE from a network policy related function node (such as PCF, SCEF, etc.), or a support system for the UE (such as OSS, or BSS, etc.). In some embodiments, the NEF 202 may determine if there is a PCF already allocated to serve the UE. If it is determined that there is a PCF (such as PCF 203) already allocated to serve the UE, then the NEF 202 sends a “Discover QoS Profiles request” to the PCF 203, as shown at 320.

This “Discover QoS Profiles request” may include the AF identifier, the identifier of the target UE, and the query parameters which are received at step 310, and the S-NSSAI and DNN associated to the AF identifier. For example, when the UE is registered into a network slice and has a PDU session opened towards the DNN, it can be determined that a PCF is serving the target UE, and the “Discover QoS Profiles request” would be sent to this serving PCF.

If the target UE does not currently have an allocated PCF, then the NEF 202 selects a suitable PCF for the target UE, the S-NSSAI, and DNN associated with the AF 201. For example, a default PCF or a central PCF would be selected. Then, the “Discover QoS Profiles request” would be sent to this selected PCF. Alternatively, the NEF 202 can also contact an OSS/BSS supporting the target UE, since the required data is also available in the OSS/BSS. In this case, the “Discover QoS Profiles request” would be sent to the OSS/BSS supporting the target UE.

According to the “Discover QoS Profiles request”, the PCF 203 may search eligible QoS references and QoS profiles, which meet QoS requirements indicated in the “Discover QoS Profiles request”. Then, as shown at step 330, the PCF 203 may send these eligible QoS references and QoS profiles a “Discover QoS Profiles response” to the NEF 202. In an example, the PCF 203 may determine a category of the target UE and then determine one or more QoS references or QoS profiles that apply to the AF 201, the S-NSSAI and DNN associated with the AF 201, and the category of the target UE. Then, the PCF 203 filters the results (e.g., the determined one or more QoS references or QoS profiles) by the QoS parameters requested by the AF 201 and/or the NEF 202, and returns a list including QoS profiles and QoS parameters that apply to each QoS profile, along with QoS references that can be used at a later time to request the applicability of respective QoS profiles. The list of QoS parameters may also include charging information related to respective QoS profiles.

Table 3 depicts an exemplary define or information elements of a QoS profile. It can be appreciated that the QoS profile are not limited to the information elements in Table 3, but may comprise any other information elements of one or more QoS attributions for the target UE.

TABLE 3
Definition of type QoS Profile

| Information Element | Description |
|---|---|
| QoS Reference | The pointer to the QoS Profile. |
| QoS Characteristics | The QoS characteristics. |
| >5QI | The 5QI value. |
| >Resource Type | The QoS resource type indicating a |
| | QoS Flow is non-GBR, non-delay |
| | critical GBR or delay critical GBR. |
| >Allocation and Retention | The 5QI priority level (see clauses |
| Priority | 5.7.3.3 and 5.7.4 of 3GPP TS |
| | 23.501). |
| >Packet Delay Budget | The packet delay budget (see clauses |
| | 5.7.3.4 and 5.7.4 of 3GPP TS |
| | 23.501). |
| >Packet Error Rate | The packet error rate. |
| >Averaging Window | The averaging window (see clause |
| | 5.7.3.6 and 5.7.4 of 3GPP TS |
| | 23.501). |
| >Maximum Data Burst | The maximum data burst volume |
| Volume | (see clauses 5.7.3.7 and 5.7.4 of |
| | 3GPP TS 23.501). |
| QoS Parameters | The additional QoS parameters. |
| >Guaranteed Flow Bit Rate | The guaranteed flow bit rate in |
| Uplink | uplink. |
| >Guaranteed Flow Bit Rate | The guaranteed flow bit rate in |
| Downlink | downlink. |
| >Maximum Flow Bit Rate Uplink | The maximum flow bit rate in uplink. |
| >Maximum Flow Bit Rate | The maximum flow bit rate in |
| Downlink | downlink. |
| >Maximum Packet Loss Rate | The maximum packet loss rate in |
| Uplink | uplink. |
| >Maximum Packet Loss Rate | The maximum packet loss rate in |
| Downlink | downlink. |

Then, as shown at step 340, NEF 202 (or the QoS profile discovery service 212) sends a “Get QoS Profiles” response back to the AF 201. The response may include all of the information received from the PCF 203 in the previous step 330.

At a later time, the AF 201 may intend to apply one of the discovered QoS profiles to one or more QoS flows related to the target UE. In this regard, the AF 201 may select the most suitable QoS profile from the discovered QoS profiles according to respective QoS attributes. In an example, the AF 201 sends a “Create AF Session WithQoS” request to the NEF 202 to request a certain QoS for one or more QoS flows of a PDU session of the target UE, as shown in step 350. The AF 201 uses one or more QoS references pointing to the selected QoS profile, which is discovered in the previous steps, to specify the QoS parameters in the request. Optionally, the AF 201 may also include those discovered QoS references as the attribution “alternative QoS References” in the “Create AF Session WithQoS” request.

The NEF 202 determines, according to the AF identifier, the S-NSSAI and DNN associated with the AF 201, and then sends a “Create Policy Authorization” request message to the PCF 203 as shown at step 360. The message includes the AF identifier, the identity (ID) of the target UE, the S-NSSAI and DNN associated with the AF 201, flow description, QoS reference, and optionally, alternative QoS references.

As shown at step 370, the PCF 203 may send a response back to the NEF 202 indicating a “success” or “failure” result of the request. Consequently, the NEF 202 may send a “Create AF Session WithQoS” response back to the AF 201 including the result of the request.

In some embodiments, the QoS profile discovery service 212 may provide an API (named as QoS Profile Discovery API) to allow the AF 201 to discover suitable and eligible QoS profiles in order to later refer to them in the NEF AfSessionwithQoS API. This QoS Profile Discovery API is a RESTful API. The URI query parameters can be those listed in Table 2. The following resources and HTTP methods are supported by this API:

TABLE 4
Resources and methods overview

| Resource | Resource | HTTP | | Query | Request | Response |
|---|---|---|---|---|---|---|
| name | URI | method | Meaning | Parameter | Body | Body |
| QoS | /{afId}/qos-profiles | GET | Get all or queried | Refer to | None | QoS |
| Profiles | | | QoS Profiles for a | Table 2 | | Profile |
| | | | given AF and UE. | | | (refer to |
| Individual | /{afId}/qos- | GET | Read a QoS | None | None | Table 3) |
| QoS | profiles/{qosReference} | | Profile for a given | | | |
| Profile | | | QoS Reference. | | | |

In some embodiments, the AF 201 may request the QoS profiles or QoS references that are applicable to a target category of UEs, rather than requesting the QoS profiles or QoS references that are applicable to a target UE. UEs are allocated a category, within a PCF, such as “gold”, “silver”, “bronze”, etc. The UE category may be utilized to determine (i.e., authorize) QoS flows that are applicable to a UE belonging to a specific category.

In these embodiments, the procedure signaling flow is very similar to that in FIG. 3, with the differences from FIG. 3 lying that messages in step 310 and 320 include a category of UEs (e.g., “gold”, “silver”, etc.), rather than the identifier of a target UE.

In some embodiments, the NEF 202 may select an OSS/BSS function that is provisioned with the list of QoS profiles, their QoS references, available to the UE or UE category. Then, the NEF 202 (or the QoS profile discovery service 212) would try to retrieve QoS profiles for the target UE from the selected OSS/BSS. Similarly as the signaling flow in FIG. 3, the NEF 202 may send the “Discovery QoS Profile request” to the selected OSS/BSS. In response, the OSS/BSS may send the discovered eligible QoS references and QoS profiles a “Discover QoS Profiles response” to the NEF 202.

In another embodiment, the NEF 202 may determine that the user is served by a PCRF of an EPC, and then contact the PCRF over an Rx interface. This might be the case when the subscriber does not have a 5G subscription or it is not currently served by a 5GC, but by an EPC. Then, the NEF 202 (or the QoS profile discovery service 212) would try to retrieve QoS profiles for the target UE from the PCRF. Similarly as the signaling flow in FIG. 3, the NEF 202 may send the “Discovery QoS Profile request” to the PCRF. In response, the PCRF may send the discovered eligible QoS references and QoS profiles a “Discover QoS Profiles response” to the NEF 202.

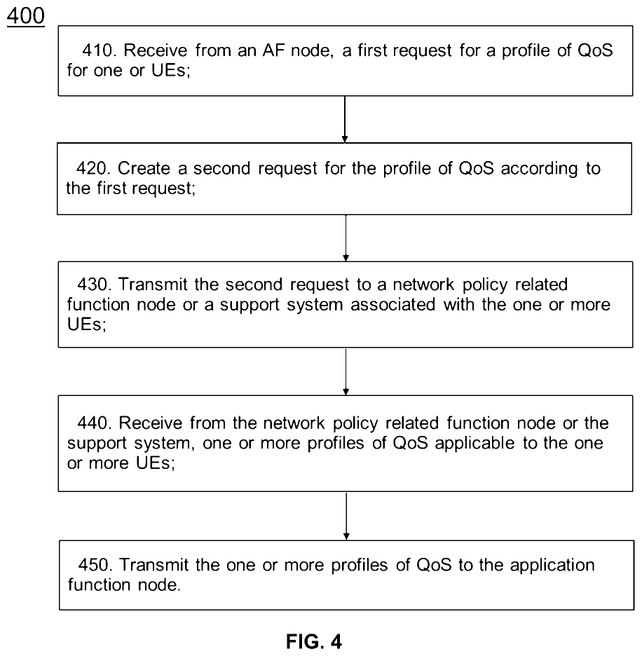

FIG. 4 illustrates a flowchart of a method 400 implemented at a network node, according to some embodiments of the present disclosure. The network node may represent any network functionality in a mobile communication network. For example, the network node may be NEF or SCEF as depicted above in conjunction with FIGS. 2 and 3.

As shown in FIG. 4, the method 400 comprises receiving from an application function node (such as AF 201), a first request for a profile of QoS, for one or more UEs, at block 410. Then, the method 400 proceeds to create a second request for the profile of QoS according to the first request, as shown at block 420. As shown at block 430, the method 400 proceeds to transmit the second request to a network policy related function node (e.g., PCF or PCRF, such as that shown in FIGS. 2 and 3) or a support system (e.g., OSS or BSS) associated with the one or more UEs. In response, one or more profiles of QoS applicable to the one or more UEs may be received from the network policy related function node or the support system, as shown at block 440. Then, the method 400 proceeds to transmit the one or more profiles of QoS to the application function node, as shown at block 450.

Although not shown in FIG. 4, the method 400 may further comprise: determining, according to the first request, the network policy control function node or the support system to which the second request is to be transmitted. In the this regard, in an example, the network node may determine if there is a network policy related function node being serving the one or more UEs. If there is a particular network policy related function node being serving the one or more UEs, then the network node may select the particular network policy related function node to transmit the second request to it. If there is no network policy related function node being serving the one or more UEs, then the network node may select a network policy related function node or a support system for the one or more UEs to transmit the second request to it.

In some embodiments, the first request may comprise: an identity of the application node (e.g., AF ID); one or more identifiers of the one or more UEs; and one or more parameters related to a requested profile of QoS. The one or more identifiers of the one or more UEs comprise at least one of the following: respective identities (e.g., SUPI, GPSI, etc.) of the one or more UEs; an identity of a group which the one or more UEs belong to; and an identifier of a category which the one or more UEs belong to. The one or more parameters related to the requested profile of QoS comprise one or more QoS attributions requested for the one or more UEs.

In some embodiments, the second request may comprise: an identity of the application node; single network slice selection assistance information (S-NSSAI) related to the application function node; a data network name (DNN) related to the application function node; one or more identifiers of the one or more UEs; and one or more parameters related to a requested profile of QoS.

The one or more profiles of QoS applicable to the one or more UEs comprise at least one of the following items: respective QoS references of the one or more profiles; one or more QoS characteristics related to the one or more parameters in the first request; and one or more QoS parameters related to the one or more parameters in the first request.

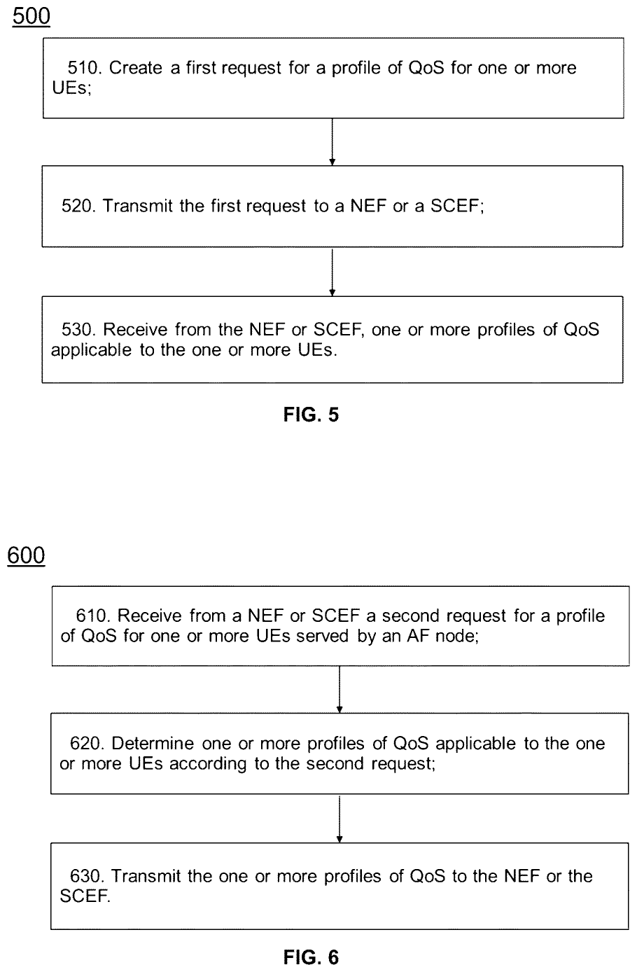

FIG. 5 illustrates a flowchart of a method implemented at a network policy related function node or a support system according to some embodiments of the present disclosure. For example, the network policy related function node may be PCF or PCRF as depicted above in conjunction with FIGS. 2 and 3. The support system may be OSS or BSS as depicted above in conjunction with FIGS. 2 and 3.

As shown in FIG. 5, the method 500 comprises: receiving from a NEF or a SCEF (such as NEF/SCEF 202), a second request for a profile of QoS, for one or more UEs served by an application function node (such as an AF 201), at block 510. As shown at block 520, the method proceeds to determine one or more profiles of QoS applicable to the one or more UEs according to the second request. Then, the method proceeds to transmit the one or more profiles of QoS to the NEF or the SCEF, as shown at block 530.

FIG. 6 illustrates a flowchart of a method implemented at an application function node, according to some embodiments of the present disclosure. The application function node may be an AF as depicted above in conjunction with FIGS. 2 and 3.

As shown in FIG. 6, the method 600 comprises: creating a first request for a profile of QoS for one or more UEs, as shown at block 610. As shown at block 620, the method proceeds to transmit the first request to a NEF or a SCEF, such as NEF/SCEF 202 as shown in FIGS. 2 and 3. In response, one or more profiles of QoS applicable to the one or more UEs may be received from the NEF or SCEF, as shown at block 630.

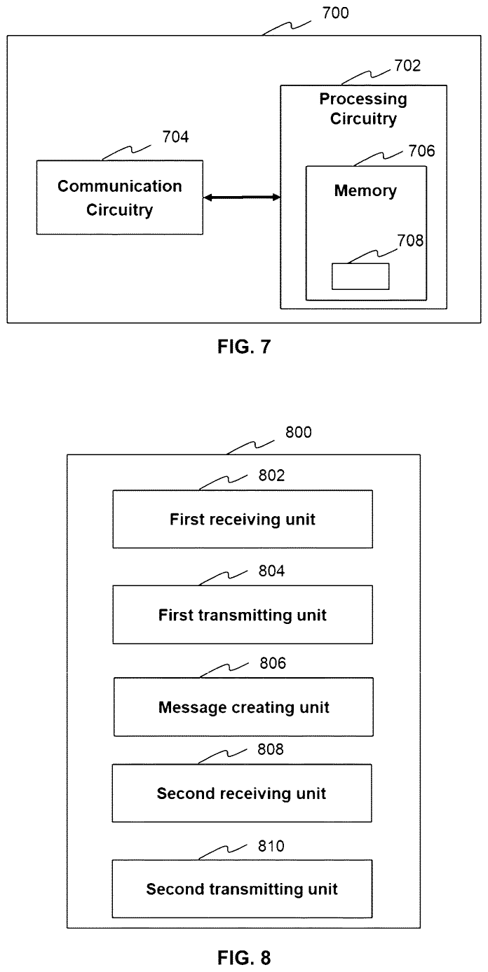

Now, reference is made to FIG. 7, illustrating a simplified block diagram of an apparatus 700 that may be embodied in/as a network node (such as a NEF, SCEF), a network policy related function node (such as PCF, PCRF), an support system (such as OSS, BSS), or an application function node (such as an AF), and some of its components configured according to an embodiment of the present disclosure.

As seen in FIG. 7, the apparatus 700 comprises processing circuitry 702 and communication circuitry 704. The communication circuitry 704 is configured to transmit and/or receive information to and/or from one or more application nodes, one or more network policy related function nodes, and/or one or more support systems, via any communication technology. Such messages include, but are not limited to, the previously described request and response messages communicated among NEF/SCEF 202, AF 201, PCF/PCRF 203 and OSS/BSS 203. The processing circuitry 702 is configured to perform processing described above, such as by executing instructions (e.g., a control program) 708 stored in memory 706, and in one embodiment, is configured to implement certain functional means, units, or modules, such as those illustrated in FIGS. 8, 9 and 10 below.

FIG. 8 is a functional block diagram of processing circuitry in a network node, such as an NEF, operating according to an embodiment of the present disclosure. As seen in FIG. 8, the network node 800 implements various functional means, units, or modules, e.g., via the processing circuitry 702 and/or via software code. These functional means, units, or modules, e.g., for implementing the method(s) herein, include for example, a first receiving unit 802, a first transmitting unit 804, a message creating unit 806, a second receiving unit 808, and a second transmitting unit 810. Each of these units 802, 804, 806, 808 and 810 are configured according to embodiments disclosed herein to implement the previously described aspects of the present disclosure.

In particular, the first receiving unit 802 is configured to receive from an application function node (such as AF 201), a first request for a profile of QoS for one or more UEs. The first request may be a “Get QoS Profiles request” as shown in step 310 of FIG. 3.

The message creating unit 806 is configured to create a second request for the profile of QoS according to the first request. The first transmitting unit 808 is configured to transmit the second request to a network policy related function node (such as PCF/PCRF 203) or a support system (such as OSS/BSS 204) associated with the one or more UEs. The second request may be a “Discover QoS Profiles request” sent in step 320 of FIG. 3.

In response, the second receiving unit 810 is configured to receive from the network policy related function node (such as PCF/PCRF 203) or the support system (such as OSS/BSS 204), one or more profiles of QoS applicable to the one or more UEs. The one or more profiles may be delivered in a “Discover QoS Profiles response” in step 330 of FIG. 3.

The first transmitting unit 804 is configured to transmit the one or more profiles of QoS to the application function node (such as AF 201), in response to the first request. The one or more profiles may be transmitted via a “Get QoS Profiles response” as shown in step 340 of FIG. 3.

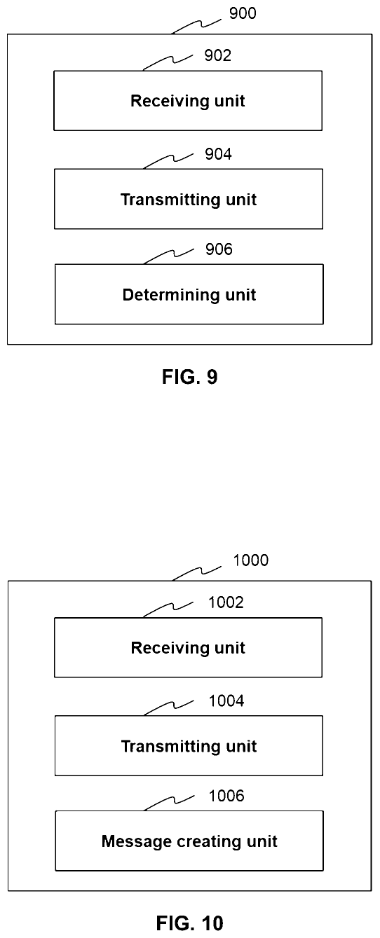

FIG. 9 is a functional block diagram of processing circuitry in a network policy related function node (such as PCF, PCRF) or an support system (such as OSS, BSS), operating according to an embodiment of the present disclosure. As seen in FIG. 9, the network policy related function node or the support system 900 implements various functional means, units, or modules, e.g., via the processing circuitry 702 and/or via software code. These functional means, units, or modules, e.g., for implementing the method(s) herein, include for example, a receiving unit 902, a transmitting unit 904, and a determining unit 906. Each of these units 902, 904, and 906 are configured according to embodiments disclosed herein to implement the previously described aspects of the present disclosure.

In particular, the receiving unit 902 is configured to receive from a network exposure server or a service capability exposure server (such as NEF/SCEF 202), the second request for a profile of QoS for one or more UEs served by an application function node (such as AF 201). The second request may be a “Discover QoS Profiles request” sent in step 320 of FIG. 3.

The determining unit 906 is configured to determine one or more profiles of QoS applicable to the one or more UEs according to the second request.

The transmitting unit 904 is configured to transmit the one or more profiles of QoS to the NEF or the SCEF. The one or more profiles may be delivered in a “Discover QoS Profiles response” as shown in step 330 of FIG. 3

FIG. 10 is a functional block diagram of processing circuitry in an application function node, such as an AF, operating according to an embodiment of the present disclosure. As seen in FIG. 10, the application function node 1000 implements various functional means, units, or modules, e.g., via the processing circuitry 702 and/or via software code. These functional means, units, or modules, e.g., for implementing the method(s) herein, include for example, a receiving unit 1002, a transmitting unit 1004, and a message creating unit1006. Each of these units 1002, 1004, and 1006 are configured according to embodiments disclosed herein to implement the previously described aspects of the present disclosure.

In particular, the message creating unit 1006 is configured to create a first request for a profile of QoS for one or more UEs. The transmitting unit 1004 is configured to transmit the first request to a network exposure server or a service capability exposure server (such as NEF/SCEF 202). The first request may be a “Get QoS Profiles request” as shown in step 310 of FIG. 3. The receiving unit 1002 is configured to receive from the NEF or SCEF, one or more profiles of QoS applicable to the one or more UEs. The one or more profiles may be received via a “Get QoS Profiles response” as shown in step 340 of FIG. 3.

Those of ordinary skill in the art will also appreciate that embodiments herein further include corresponding computer programs, such as control program 708 illustrated in FIG. 7. According to the present disclosure, control program 708 comprises instructions which, when executed on at least one processor of an apparatus (e.g., processing circuitry 702 on the apparatus 700 seen in FIG. 7), cause the apparatus to carry out any of the respective processing described above. A control program 708 in this regard may comprise one or more code modules corresponding to the means or units described above.

Embodiments further include a carrier containing such a computer program 708. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus (e.g., apparatus 700) to perform the functions of the present embodiments as described above.

Embodiments further include a computer program product comprising program code portions for performing the steps of any of the embodiments herein when the computer program product is executed by a computing device. This computer program product may be stored on a computer readable recording medium, such as memory 706.

Embodiments of this disclosure can provide an in-band approach to facilitate AF developers to retrieve QoS references identifying QoS profiles that are applicable to the categories associated to a target UE or to a UE category. Using the query parameters, as QoS requirements, the AF developers can discover the most suitable QoS Profiles to fulfil the service needs. Since the QoS Profile Discovery API is readable by a machine, the API can make the network-exposure-controlled QoS procedure fully automated and adaptive. This eliminates tedious and error-prone operations requiring copying QoS references from documentation to APIs.

Embodiments of this disclosure can also allow modification of the QoS references and the available QoS profiles during the lifetime of the SLA. New QoS profiles (including QoS references) may be added, and old QoS profiles may be deleted, without requiring any change on the AF side. This is because the QoS profile discovered by the AF from the network via a NEF can include the QoS attributes according to a latest QoS policy or SLA.

It is noted that some embodiments of the present disclosure are mainly described in relation to 5G specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1. A method implemented at a network node, the method comprising:
receiving from an application function node, a first request for a profile of quality of service (QoS) for one or more user equipments (UEs);
creating a second request for the profile of QoS according to the first request;
transmitting the second request to a network policy related function node or a support system associated with the one or more UEs;
receiving from the network policy related function node or the support system, one or more profiles of QoS applicable to the one or more UEs; and
transmitting the one or more profiles of QoS to the application function node.

2. The method according to claim 1, further comprising:
determining, according to the first request, the network policy control function node or the support system to which the second request is to be transmitted.

3. The method according to claim 2, wherein the determining comprises:
determining if there is a network policy related function node being serving the one or more UEs; and
if there is a particular network policy related function node being serving the one or more UEs, selecting the particular network policy related function node to transmit the second request to it.

4. The method according to claim 2, wherein the determining comprises:
determining if there is a network policy related function node being serving the one or more UEs; and
if there is no network policy related function node being serving the one or more UEs, selecting a network policy related function node or a support system for the one or more UEs to transmit the second request to it.

5. The method according to claim 1, wherein the first request comprises the following parameters:
an identity of the application node;
one or more identifiers of the one or more UEs; and
one or more parameters related to a requested profile of QoS.

6. The method according to claim 1, wherein the second request comprises the following parameters:
an identity of the application node;
single network slice selection assistance information related to the application function node;
a data network name related to the application function node;
one or more identifiers of the one or more UEs; and
one or more parameters related to a requested profile of QoS.

7. The method according to claim 5, wherein the one or more identifiers of the one or more UEs comprise at least one of the following:
respective identities of the one or more UEs;
an identity of a group which the one or more UEs belong to; and
an identifier of a category which the one or more UEs belong to.

8. The method according to claim 5, wherein the one or more parameters related to the requested profile of QoS comprise one or more QoS attributions requested for the one or more UEs.

9. The method according to claim 5, wherein the one or more profiles of QoS applicable to the one or more UEs comprise at least one of the following items:
respective QoS references of the one or more profiles;
one or more QoS characteristics related to the one or more parameters in the first request; and
one or more QoS parameters related to the one or more parameters in the first request.

10. The method according to claim 1, wherein the network node comprises a network exposure server (NEF) or a service capability exposure server (SCEF).

11. A method implemented at a network policy related function node or a support system, the method comprising:
receiving from a network exposure server (NEF) or a service capability exposure server (SCEF), a second request for a profile of quality of service (QoS) for one or more user equipments (UEs) served by an application function node;
determining one or more profiles of QoS applicable to the one or more UEs according to the second request; and
transmitting the one or more profiles of QoS to the NEF or the SCEF.

12. The method according to claim 11, wherein the second request comprises the following parameters:
an identity of the application node;
single network slice selection assistance information related to the application function node;
a data network name related to the application function node;
one or more identifiers of the one or more UEs; and
one or more parameters related to a requested profile of QoS.

13. The method according to claim 11, wherein the one or more identifiers of the one or more UEs comprise at least one of the following:
respective identities of the one or more UEs;
an identity of a group which the one or more UEs belong to; and
an identifier of a category which the one or more UEs belong to.

14. The method according to claim 11, wherein the one or more parameters related to the requested profile of QoS comprise one or more QoS attributions requested for the one or more UEs.

15. The method according to claim 11, wherein the one or more profiles of QoS applicable to the one or more UE comprises at least one of the following items:
respective QoS references of the one or more profiles;
one or more QoS characteristics related to the one or more parameters; and
one or more QoS parameters related to the one or more parameters.

16. The method according to claim 11, wherein the network policy related function node comprises a policy control function (PCF) node or a policy charging rules function (PCRF) node.

17. (canceled)

18. (canceled)

19. (canceled)

20. (canceled)

21. (canceled)

22. An apparatus at a network node, the apparatus comprising:
one or more processors; and
one or more memories comprising computer program codes,
the one or more memories and the computer program codes configured to, with the one or more processors, cause the apparatus to:
receive from an application function node, a first request for a profile of quality of service (QoS) for one or more user equipments (UEs);
create a second request for the profile of QoS according to the first request;
transmit the second request to a network policy related function node or a support system associated with the one or more UEs;
receive from the network policy related function node or the support system, one or more profiles of QoS applicable to the one or more UEs; and
transmit the one or more profiles of QoS to the application function node.

23. The apparatus according to claim 22, wherein the one or more memories and the computer program codes are further configured to, with the one or more processors, cause the apparatus to determine, according to the first request, the network policy control function node or the support system to which the second request is to be transmitted.

24. An apparatus at a network policy related function node or a support system, the apparatus comprising:
one or more processors; and
one or more memories comprising computer program codes,
the one or more memories and the computer program codes configured to, with the one or more processors, cause the apparatus to:
receive from a network exposure server (NEF) or a service capability exposure server (SCEF), a second request for a profile of quality of service (QoS) for one or more UEs served by an application function node;
determine one or more profiles of QoS applicable to the one or more UEs according to the second request; and
transmit the one or more profiles of QoS to the NEF or the SCEF.

25. The apparatus according to claim 24, wherein the second request comprises the following parameters: an identity of the application node; single network slice selection assistance information related to the application function node; a data network name related to the application function node; one or more identifiers of the one of more UEs; and one or more parameters related to a requested profile of QoS.

26. (canceled)

27. (canceled)

28. (canceled)

29. (canceled)

30. (canceled)
